(19) United States
(12) Patent Application Publication
(10) Pub. No.: US 2014/0181749 A1
(43) Pub. Date: Jun. 26, 2014

(54) USER INTERFACE DEVICE AND PROGRAM FOR THE SAME

(71) Applicant: Denso Corporation, Kariya-city (JP)

(72) Inventor: Hiroya TAKIKAWA, Kariya-city (JP)

(73) Assignee: DENSO CORPORATION, Kariya-city (JP)

(21) Appl. No.: 14/095,086

(22) Filed: Dec. 3, 2013

(30) Foreign Application Priority Data
Dec. 20, 2012 (JP) 2012-278268

(51) Int. Cl. G06F 3/0482; G06F 3/0481

(52) U.S. Cl. CPC G06F 3/0482; G06F 3/04817
USPC 715/835; 715/840

(57) ABSTRACT

A user interface device for controlling a display portion for displaying a menu screen including a list of buttons and a cursor includes an operation input device, and a display control portion. The operation input device inputs an instruction direction corresponding to a user operation. The display control portion controls the display portion to display a shape of the operation input device as the cursor and to move the cursor among the list based on the instruction direction. The display control portion superimposes at least one guide image on the cursor. The guide image represents an operable direction of the operation input device and function of a button. A user interface device includes a display portion, an operation input device, and a display control portion. A non-transitory tangible computer readable storage medium storing a computer-executable program to cause a computer to perform is provided.

### CROSS REFERENCE TO RELATED APPLICATION

This application is based on Japanese Patent Application No. 2012-278268 filed on Dec. 20, 2012, the disclosure of which is incorporated herein by reference.

### TECHNICAL FIELD

The present disclosure relates to a user interface device for performing a display control according to a user operation, and a program for the user interface device.

### BACKGROUND

Conventionally, a vehicle user interface device is disclosed as a user interface device that is placed to a vehicle. The vehicle user interface device displays multiple items, indicating contents of a variety of application processes (e.g., a control process for an air conditioner or audio equipment) executed in a vehicle, as a menu screen on a meter display. The vehicle user interface device moves a cursor displayed on each of the multiple items among multiple items according to an operation instruction of a driver, which is inputted through a steering switch.

In addition, as the cursor moving among items on the menu screen, an item to be selected by the user is generally surrounded for emphasis (referring to FIG. 8A). Furthermore, it is proposed that an item in the cursor is enlarged and displayed (e.g., referring to JP-A-2005-301703).

However, the inventor of the present disclosure has found the following difficulty with respect to a user interface device. According to a conventional cursor display manner, it may be difficult to intuitively know a switch that the user should operate to moves the cursor. Specifically, according to a conventional vehicle user interface device, when multiple steering switches are placed or when other switches in addition to the multiple steering switches are placed at each portion in the vehicle, it may be difficult to quickly determine a switch that the driver should operate during vehicle driving. The conventional user interface device may do not have good operability.

### SUMMARY

It is an object of the present disclosure to provide a user interface device in which a user selects one of multiple items on a menu screen with using a cursor that moves between the multiple items. According to the user interface device, it may be possible to improve operability to the user.

According to a first aspect of the present disclosure, the user interface device for controlling a display portion for displaying a menu screen including a list of buttons and a cursor includes an operation input device, and a display control portion. The operation input device inputs an instruction direction corresponding to a user operation. The display control portion controls the display portion to display a shape of the operation input device as the cursor and to move the cursor among the list based on the instruction direction. The display control portion superimposes at least one guide image on the cursor. The guide image represents at least one of an operable direction of the operation input device and function of a button based on a position of the cursor on the list.

According to a second aspect of the present disclosure, a non-transitory tangible computer readable storage medium storing a computer-executable program is provided. The computer-executable program causes a computer, which is connected to (i) a display portion for displaying a menu screen including a list of buttons and a cursor, and (ii) an operation input device for inputting an instruction direction corresponding to a user operation, to perform controlling the display portion to display a shape of the operation input device as the cursor and to move the cursor among the list based on the instruction direction. At least one guide image is superimposed on the cursor. The guide image represents at least one of an operable direction of the operation input device and function of a button based on a position of the cursor on the list.

According to a third aspect of the present disclosure, the user interface device includes a display portion, an operation input device, and a display control portion. The display portion displays a menu screen including a plurality of items. The operation input device inputs an instruction direction corresponding to a user operation. The display control portion, when a cursor for enabling a user to select one of the plurality of items is displayed on the one of the plurality of items in the menu screen on the display portion, moves the cursor between the plurality of items according to the instruction direction inputted through the operation input device. The plurality of items, respectively, represents contents of a plurality of application processes prepared in advance. A device icon represents a shape of the operation input device. The display control portion displays the device icon on the menu screen as the cursor.

According to a fourth aspect of the present disclosure, a non-transitory tangible computer readable storage medium storing a computer-executable program is provided. The computer-executable program that causes a computer, which is connected to a display portion for displaying a menu screen including a plurality of items and an operation input device for inputting an instruction direction corresponding to a user operation, to perform, when a cursor for enabling a user to select one of the plurality of items is displayed on the one of the plurality of items on the display portion, moving the cursor on the display portion between the plurality of items according to the instruction direction inputted through the operation input device, and displaying a device icon the menu screen as the cursor. The device icon represents a shape of the operation input device. The plurality of items, respectively, represents contents of a plurality of application processes prepared in advance.

According to the above aspects of the present disclosure, it is possible that, when the user selects the item, the user knows a switch that the user operates at a glance. It is possible that the user knows the selected item without moving the user's eyes when the user looks at the device icon. It is possible to improve operability to the user according to a configuration that the user selects with the cursor, which moves between items on the menu screen.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a block diagram illustrating an example of an overall configuration of system including a user interface device;

FIG. 1B is a block diagram illustrating another example of an overall configuration of system including the user interface device;

FIG. 2A is a diagram illustrating an example of an operation input device, a display portion, and an additional device;

FIG. 2B is a diagram illustrating an example of a meter display in a normal mode;

FIG. 2C is a diagram illustrating an example of a meter display in an application mode;

FIG. 3 is a flow chart illustrating a display control process executed by the user interface device;

FIG. 4 is a flow chart illustrating a display control process in the application mode;

FIG. 5A is a diagram illustrating an first screen image representing a display screen of the user interface device;

FIG. 5B is a diagram illustrating an example of the first screen image representing the display screen of the user interface device;

FIG. 5C is a diagram illustrating another example of the first screen image representing the display screen of the user interface device;

FIG. 5D is a diagram illustrating another example of the first screen image representing the display screen of the user interface device;

FIG. 6A is a diagram illustrating a second screen image representing the display screen of the user interface device;

FIG. 6B is a diagram illustrating an example of the second screen image representing the display screen of the user interface device;

FIG. 6C is a diagram illustrating another example of the second screen image representing the display screen of the user interface device;

FIG. 6D is a diagram illustrating another example of the second screen image representing the display screen of the user interface device;

FIG. 7 is a diagram illustrating a third screen image representing the display screen of the user interface device;

FIG. 8A is a diagram illustrating an example of a fourth screen image representing the display screen of the user interface device; and

FIG. 8B is a diagram illustrating another example of a fourth screen image representing the display screen of the user interface device.

### DETAILED DESCRIPTION

An embodiment of a vehicle user interface device of the present disclosure will be explained with referring to drawings.

(Overall Configuration)

An overall configuration of an in-vehicle network system 2 including the vehicle user interface device 1 will be explained.

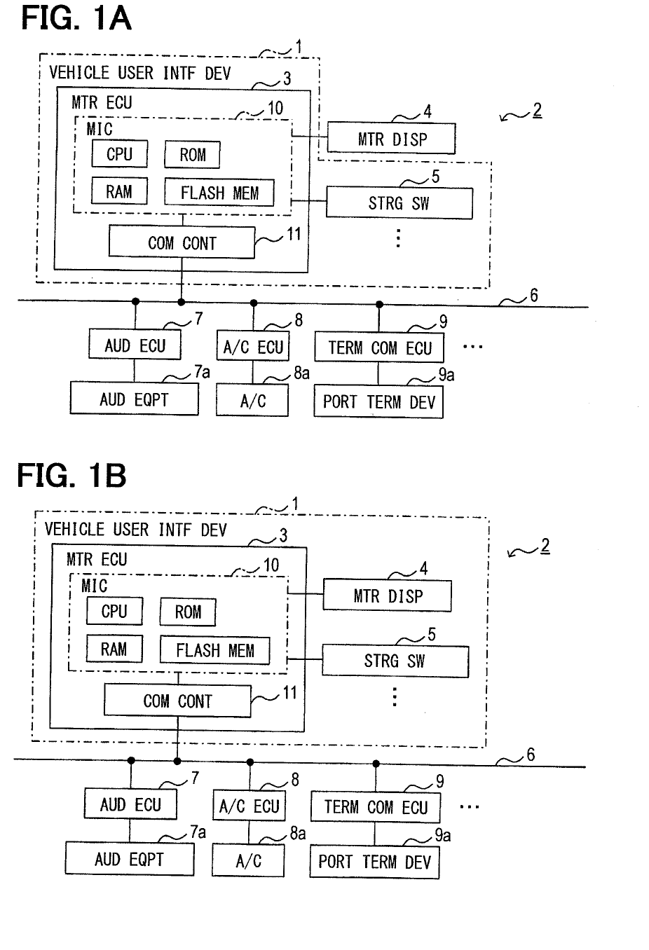

As described in FIG. 1A and FIG. 1B, the vehicle user interface device 1 includes a meter ECU 3. The meter ECU 3 is one of multiple electronic control units (ECUs) which constitute the in-vehicle network system 2 configured within the vehicle. The meter ECU 3 performs a display control of a meter display 4, which is placed in the vehicle. Specifically, as shown in FIG. 1B, the vehicle user interface device 1 includes the meter ECU 3, the meter display 4, and multiple steering switches 5. The meter ECU 3 corresponds to a display control means or a display control portion. The meter display 4 corresponds to a display portion.

Alternatively, the vehicle user interface device 1 may include the meter ECU 3 and multiple steering switches 5 and may not include the meter display 4, as described in FIG. 1A.

The meter ECU 3 includes a well-known microcomputer having a CPU, an ROM, an RAM, or a flash memory. Specifically, the meter ECU 3 includes the microcomputer 10 and a communication controller 11.

The communication controller 11 performs data communication between other ECUs that configure the in-vehicle network system 2, through a communication bus 6. The communication controller 11, according to a predetermined protocol (e.g., a well-known CAN protocol), transmits a transmission data, which is generated by the microcomputer 10, to the communication bus 6, or supplies data, which is received from the other ECUs through the communication bus 6, to the microcomputer 10.

Incidentally, each of the other ECUs, which configure the in-vehicle network system 2, may include a microcomputer and a communication controller, similar to the meter ECU 3. The other ECUs include an audio ECU 7, an air conditioner ECU 8, a terminal communication ECU 9, or the like. The audio ECU 7 controls an audio equipment 7a. The air conditioner ECU 8 controls an air conditioner 8a. The terminal communication ECU 9 corresponds to an ECU for controlling a portable terminal device 9a, which is carried into the vehicle. The terminal communication ECU 9 controls a mobile phone or a smartphone of a driver.

Specifically, the audio ECU 7 performs application processes. The application processes include selection and play of contents which are intended by the user such as the driver. The application processes includes an adjustment of volume, a fast-forwarding or rewinding of music data or video data of the contents. The air conditioner ECU 8 performs application processes, which are related to selection of an air conditioning mode, a switching of turning on and off, a temperature adjustment, or the like. The terminal communication ECU 9 cooperates with the smartphone or the like, and performs application processes, which are related to transmission and reception of a phone call or an e-mail, a browse of a homepage on an internet, navigation, or the like.

The ECUs 7 to 9 perform data communication to the meter ECU 3 through the communication bus 6 such that the ECUs 7 to 9 cooperate with the meter ECU 3 and perform the application processes. Specifically, when the driver selects one of the application processes with the steering switch 5, a control data for specifying the one of the application processes is transmitted from the meter ECU 3 to the ECUs 7 to 9 through the communication bus 6. Based on the control data, the ECUs 7 to 9 perform the application process corresponding to an operation by the driver.

Thus, in the vehicle user interface device 1, the meter ECU 3 and the ECUs 7 to 9 correspond to an operation object device by the steering switch 5. Incidentally, in the present embodiment, output contents of the application process performed by the ECUs 7 to 9 are transmitted from the ECUs 7 to 9 to the meter ECU 3 through the communication bus 6. Control data which indicates a run condition of the ECUs 7 to 9 is transmitted from the ECUs 7 to 9 to the meter ECU 3 through the communication bus 6. The meter ECU 3 may display an image on the meter display 4, based on the control data.

Herein, the application process corresponds to a process for controlling a control object device. In the microcomputer 10 of the meter ECU 3 or microcomputers of ECUs 7 to 9, a CPU controls the control object device (e.g., the audio equipment 7a, the air conditioner 8a, the portable terminal device 9a, or the like), based on an application software stored in the ROM or the flash memory. Each of the control object device is allocated each of the meter ECU 3 and the ECUs 7 to 9. The application software is multiply allocated to the control object device in advance, and directly has a function that the user such as the driver wants to realize.

(Configuration of Steering Switch and Meter Display)

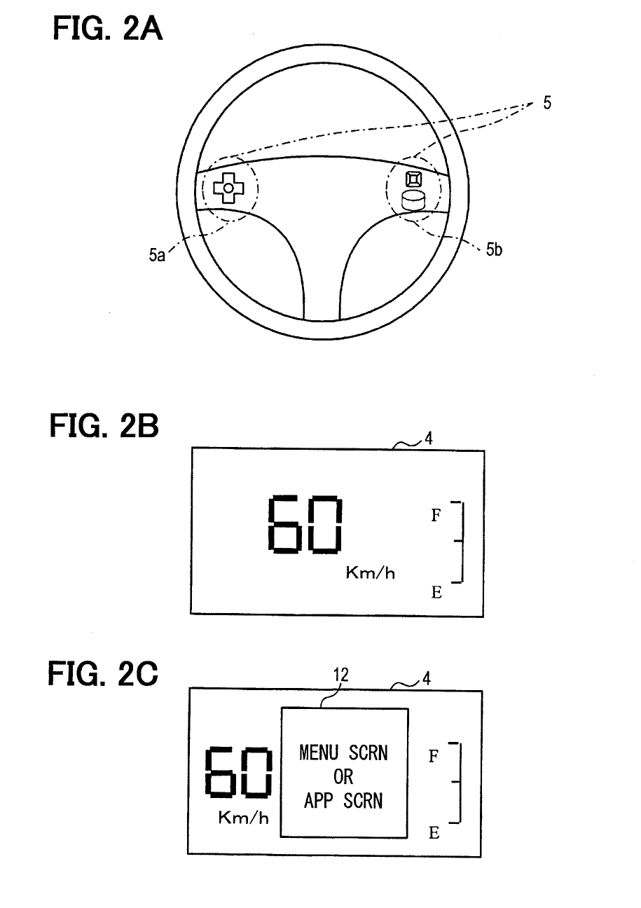

A configuration of the steering switch 5 and the meter display 4 will be explained. As described in FIG. 2A, multiple steering switches 5 are placed in a steering spoke of the vehicle and placed at from side to side adjacent to a grip portion in the steering wheel. The multiple steering switches 5 include an arrow key 5a and two independent buttons 5b. The arrow key 5a is placed in a left side of the steering wheel. The arrow key 5a has an up switch, a down switch, a left switch, and a right switch. The arrow key 5a functions as an operation input device to input an instruction direction to the microcomputer 10. The instruction direction is determined by a push position according to a switch operation by the user. The two independent buttons 5b are placed in a right side of the steering wheel. The two independent buttons 5b correspond to an additional device.

The two independent buttons 5b have a small square switch and a large circular switch. The square switch and the circular switch are placed up and down. The square switch is located at an upper position than the circular switch.

The two independent buttons 5b function as an additional switch, and input instruction content, according to each operation, to the microcomputer 10. The square switch is configured to be able to receive a push operation and calls a menu screen 12, which is described below. The circular switch is configured to be able to receive the push operation and a rotation operation, and for example, is used for volume adjustment of the audio equipment 7a or temperature adjustment of the air conditioner 8a through the rotation operation.

The meter display 4 is a display that is placed within a dashboard in front of a driver seat of the vehicle. The meter display 4 mainly displays vehicle information, which indicates a vehicle condition. The vehicle information includes vehicle speed, engine speed, residual fuel, or the like. Incidentally, control data that represents the vehicle information is transmitted from a ECU for controlling vehicle traveling system (not shown) to the meter ECU 3 through the communication bus 6. The meter ECU 3 displays an image which is based on the control data on the meter display 4.

The meter display 4 has two display modes: a normal mode and an application mode. In the normal mode, the vehicle information is displayed at the substantial center of the meter display 4 (referring to FIG. 2B). In the application mode, the vehicle information is displayed at a side of the meter display 4, and an application screen is displayed at the substantial center of the meter display 4 (referring to FIG. 2C). The application screen represents the menu screen 12 or output content of the application process.

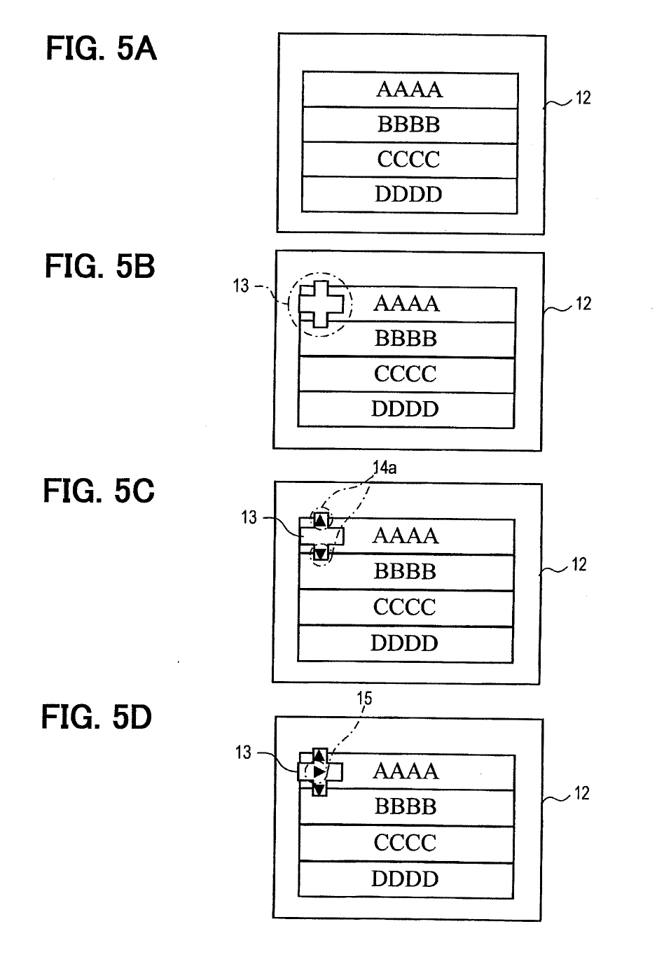

The menu screen 12 basically is, as described in FIG. 5A, configured from multiple items (e.g., AAAA, BBBB, CCCC or DDDD) for indicating contents of the multiple application processes that the ECUs 7 to 9 execute. A cursor is displayed on one of the items on the menu screen 12. The cursor moves between items i.e., from an item to another item, according to the push operation to the arrow key 5a by the user. For example, when the user performs the push operation with the up switch or the down switch, the cursor moves up or down.

Incidentally, the item on the menu screen 12 corresponds to a button, and therefore the multiple items correspond to a list of the buttons.

(Display Control Process of Meter ECU)

A display control process that the CPU performs in the microcomputer 10 of the meter ECU 3 will be explained. The CPU executes the display control process with using the RAM as a working area, based on a program stored in the ROM or the flash memory.

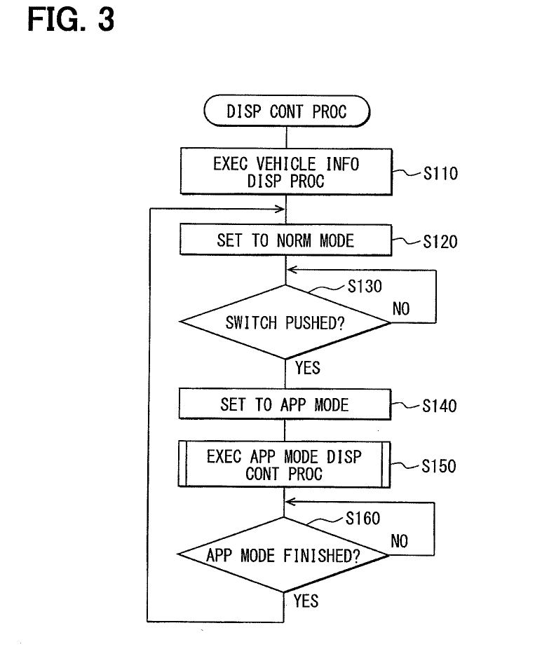

As described in FIG. 3, when an ignition switch of the vehicle turns on, the microcomputer 10 (accurately, the CPU) receives vehicle information from the communication bus 6 through the communication controller 11. The microcomputer 10 starts up a vehicle information display process. In the vehicle information display process, the microcomputer 10 displays the vehicle information on the meter display 4 (S110). The microcomputer 10 sets the normal mode as the display mode of the meter display 4, and displays the vehicle information, obtained at S110, at the center of the meter display 4 (S120).

The microcomputer 10 determines whether the square switch in the steering switch 5 is pushed (S130). When the push operation to the square switch is detected (“YES” at S130), a setting of the display mode of the meter display 4 is replaced from the normal mode to the application mode. The vehicle information, obtained at S110, is displayed at a side of the meter display 4 (S140), and the menu screen 12 is displayed at the center of the meter display 4. Thus, an application mode display control process stars up (S150). The application mode display control process performs the display control of the meter display 4 in the application mode. When the push operation is not detected (“NO” at S130), the microcomputer 10 does not replace a setting of the display mode of the meter display 4 and waits.

The microcomputer 10 in the application mode display control process determines whether a trigger to stop the application mode is detected (S160). The trigger includes a case where the square switch is pushed again during displaying the menu screen 12, and where an application process finished during displaying the application screen, for example. When the microcomputer 10 detects the trigger (“YES” at S160), the process returns to S120, and the setting of the display mode of the meter display 4 is replaced from the application mode to the normal mode. When the microcomputer 10 does not detect the trigger (“NO” at S160), the microcomputer does not replace the setting of the display mode of the meter display 4 and waits.

(Application Mode Display Control Process)

The application mode display control process that the microcomputer 10 of the meter ECU 3 executes will be explained.

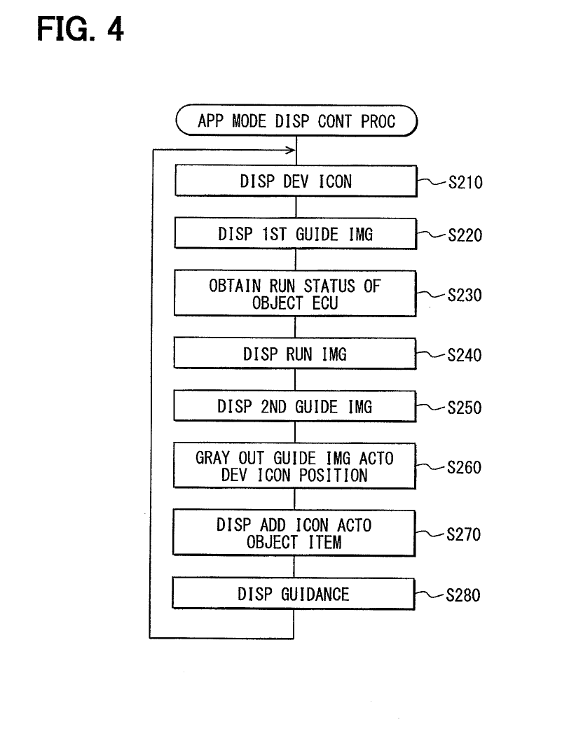

As described in FIG. 4, when the application mode display control process starts, the microcomputer 10 displays an icon (hereinafter, referred to as a device icon) 13 on the meter display 4 (S210), so that the device icon is displayed on one of the items in the menu screen 12. The device icon has a shape of the arrow key 5a. Specifically, as described in FIG. 5B, the device icon 13 is placed on a left side or the like of an item name of the item so that the user can visually recognize the item name (e.g., AAAA in FIG. 5B). Incidentally, the device icon 13 is used as the cursor that moves between items, according to the push operation to either of the switches (in the preset embodiment, the up switch and the down switch) of the arrow key 5a. The arrow key 5a corresponds to the device icon 13, and corresponds to the operation input device.

The microcomputer 10 displays a first guide image 14a at a portion (hereinafter, referring to as a push icon portion) corresponding to the push position in the device icon 13 on the meter display 4 (S220). The first guide image is displayed to prompt a user operation. Specifically, the guide image 14a is, as described in FIG. 5C, an image representing a movement direction (in the present embodiment, up and down directions) of the device icon 13 in the menu screen 12, and in the present embodiment, superimposed on the push icon portion which corresponds to the up switch or the down switch of the arrow key 5a.

The microcomputer 10 obtains the control data, which indicates an operating status (corresponding to a run status) of the ECU (corresponding to one of the ECUs 7 to 9, and hereinafter, referred to as an object ECU) that executes the application process corresponding to an object item (S230). The object item of the multiple items corresponds to a position at which the device icon 13 positions.

The microcomputer 10, based on the obtained control data, displays a run image 15 on a portion (e.g., in the present embodiment, corresponding to an icon part of the center of the arrow key 5a) of the device icon 13 other than the push icon portion (S240). The run image varies according to the operating status of the object ECU.

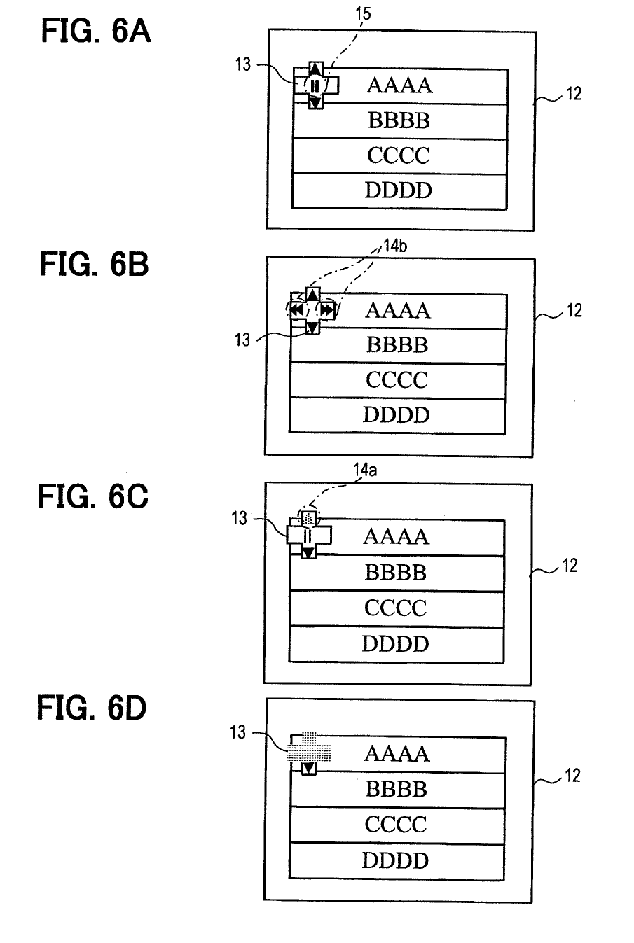

Specifically, the run image 15, may be an image representing music play as described in FIG. 5D, or may be an image representing temporal stop of music as described in FIG. 6A. In a case where the object ECU corresponds to the audio ECU 7, and when the audio equipment 7a stops according to the control of the audio ECU 7, the image representing music play is displayed. In a case where the object ECU corresponds to the audio ECU 7, and when the audio equipment 7a plays music according to the control of the audio ECU 7, the image representing temporal stop of music is displayed.

As described above, the microcomputer 10 superimposes the run image 15, which corresponds to the operating status of the object ECU, on the device icon 13, so that the microcomputer 10 replaces the run image in each time when the operating status of the object ECU changes.

Incidentally, in the present embodiment, in a case where the run image 15 on the device icon 13 is the image representing music playing by the audio equipment 7a and when the left switch or the right switch of the arrow key 5a is pushed, the audio ECU 7 executes music playing. In a case where the run image 15 is the image representing a temporal stop of music by the audio equipment 7a and when the left switch or the right switch of the arrow key 5a is pushed, the audio ECU 7 stop playing music temporarily.

The run image 15 may be an image representing an operating status of the object ECU. In this case, for example, when the audio equipment 7a stops by the control of the audio ECU 7, an image representing stop of the audio equipment 7a may be displayed. When the audio equipment 7a plays music by the control of the audio ECU 7, an image representing music playing by the audio equipment 7a may be displayed.

The microcomputer 10 displays a second guide image 14b on the push icon portion in the device icon 13 (S250). The second guide image 14b is displayed to prompt the user operation. Specifically, the second guide image 14b is, when the audio equipment 7a plays music by the control of the audio ECU 7, an image representing fast-forwarding or rewinding of music as described in FIG. 6B. In the present embodiment, the second guide image 14b is superimposed on the push icon portion corresponding to the left switch and the right switch of the arrow key 5a.

Incidentally, since the left switch or the right switch of the arrow key 5a is allocated to fast-forwarding or rewinding of music, it is supposed that the above run image is an image representing the operating status of the object ECU. In addition, the second guide image 14b may be, for example, an image representing music playing or temporal stop as described in the above process (corresponding to S240).

As described above, the microcomputer 10 displays the second guide image on the meter display 4. The menu screen 12 includes multiple items. The second guide image represents function accomplished by the application process corresponding to the object item.

The microcomputer 10, according to a position of the device icon 13 in the menu screen, grays out the guide images 14a, 14b in the arrow key 5a which correspond to the push position (hereinafter, referred to as an object position) where the push operation is not received by the user (S260). Specifically, as described in FIG. 6C, for example, when the device icon 13 is located at the top of the menu screen 12, it is impossible that the device icon 13 in the menu screen 12 moves upward. Thus, the first guide image 14a (in this case, an image indicating an upward direction) of the push icon portion corresponding to the up switch of the arrow key 5a is grayed out.

Incidentally, according to a position of the device icon 13 in the menu screen 12, when an item (corresponding to the object item) where the device icon 13 is positioned changes, the second guide image 14b (e.g., an image representing fast-forwarding or rewinding of music) of the push icon portion may be grayed out. The grayed out push icon portion corresponds to the push position (corresponding to the object position) in the arrow key 5a where the push operation is not received by the user.

Alternatively, the microcomputer 10 may gray out the push icon portion corresponding to the object position according to a position of the device icon 13 in the menu screen 12. Specifically, as described in FIG. 6D, when the device icon 13 is positioned at the top of the menu screen 12, an area covering the push icon portion which corresponds to the up switch, the left switch, and the right switch of the arrow key 5a may be grayed out.

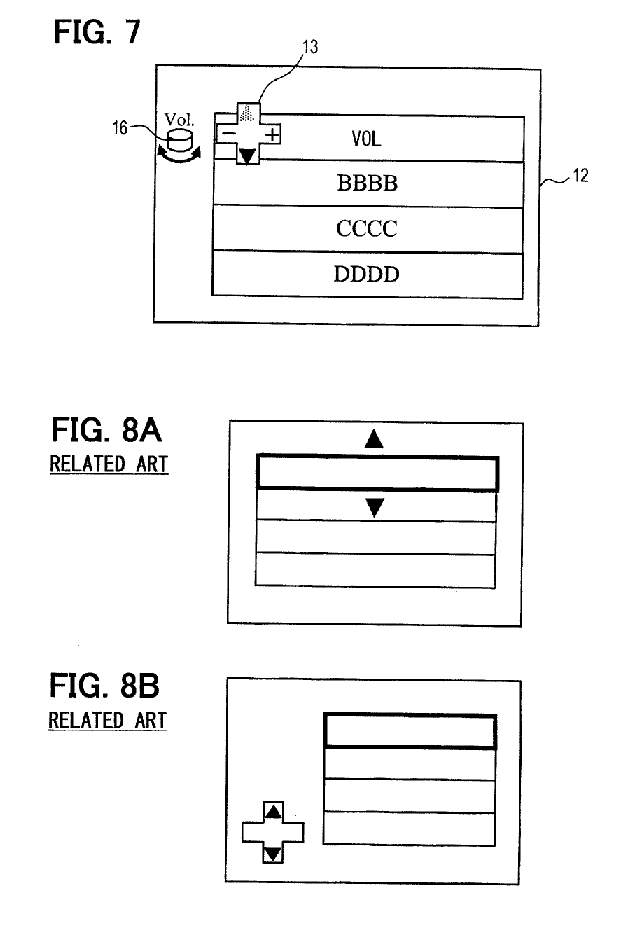

Furthermore, the microcomputer 10, when the independent button 5b responds to an operation related to the application process corresponding to the object item, displays an icon 16 (hereinafter, referred to as a additional icon 16) in the menu screen 12 (S270). The additional icon 16 has a shape of the independent button 5b (corresponding to the additional device). The additional icon 16 is placed adjacent to the device icon 13. Specifically, the additional icon 16, as described in FIG. 7, is placed at a left side or the like of the device icon 13 so that the user visually recognize the item name (e.g., volume) and the device icon 13. When the object ECU corresponds to the audio ECU 7, the additional icon 16 has a shape of the circular switch that is allocated to volume adjustment of music, for example.

As described in FIG. 7, the microcomputer 10 displays the additional icon 16, a guidance image (e.g., VOL) illustrating a rotational direction of the circular switch and a function realized by the rotation operation of the circular switch (S280). The process returns to S210.

(Technical Advantage)

As described above, in the vehicle user interface device 1, the microcomputer 10 uses the device icon 13, which has a shape of the arrow key 5a, as the cursor that is displayed on the menu screen 12. Thus, it is possible that, when the user selects the item, the user knows a switch that the user operates at a glance. It is possible that the user knows the selected item without moving the user's eyes when the user looks at the device icon 13.

Thus, according to the vehicle user interface device 1, it is possible to improve operability to the user according to a configuration that the user selects with the cursor, which moves between the multiple items on the menu screen 12.

In the vehicle user interface device 1, the microcomputer 10 superimposes the guide images 14a, 14b for prompting the user operation on the push icon portion in the device icon 13. Thus, it is possible that the user easily know a portion in the arrow key 5a, displayed on the menu screen 12, that the user should push.

In the vehicle user interface device 1, the microcomputer 10 displays the first guide image 14a, indicating the movement direction of the device icon 13. Thus, it is possible that, when the user pushes a position of the arrow key 5a, the user easily knows a movement direction of the device icon 13, which corresponds to the cursor.

In the vehicle user interface device 1, the microcomputer 10 displays the second guide image 14b, indicating a function which is realized by the application process corresponding to the item (corresponding to the object item) of the multiple items where the device icon 13 is positioned. Thus, it is possible that, when the user pushes a specific position of the arrow key 5a, the user easily knows a kind of function realized by the selected item.

In the vehicle user interface device 1, the microcomputer 10 grays out the guide images 14a, 14b corresponding to the push position (e.g., the object position) of the arrow key 5a which becomes inoperable by the user, according to a position of the device icon 13. Thus, when it becomes inoperable to move the device icon 13 as the cursor or when it becomes impossible to select an operation to realize a function by the selected item, it is possible that the user easily knows a relationship between a position and an item of the device icon 13 and a selectable/non-selectable operation.

In the vehicle user interface device 1, the microcomputer 10 grays out the push icon portion corresponding to the push position (e.g., the object position) of the arrow key 5a which becomes inoperable by the user, according to a position of the device icon 13. Thus, it is possible that the user intuitively knows a position that an operation becomes unavailable of the arrow key 5a.

In the vehicle user interface device 1, the microcomputer 10 superimposes the run image 15 on an area other than the push icon portion of the arrow key 5a. The run image 15 corresponds to the operating status of the ECUs 7 to 9 executing the application process corresponding the item (the object item) of the multiple items that the device icon 13 is positioned. Thus, it is possible that the user easily knows the push position of the arrow key 5a, and that the user knows the operating status of the ECUs 7 to 9 (corresponding to a control object device) on the menu screen 12.

According to this configuration, since it may be possible to display the menu screen 12 without displaying the application screen, it is possible that the user selects another item without an operation to back from the application screen to the menu screen 12, for example. Thus, it is possible to improve the operability to the user. Herein, the application screen indicates an output content of the application process which the ECUs 7 to 9 execute.

In the vehicle user interface device 1, the microcomputer 10, when the independent button 5b is allocated to an operation related to the application process, displays the additional icon 16 adjacent to the device icon 13. The application process corresponds to the item (the object item) of the multiple items that the device icon positions. The additional icon 16 in the menu screen 12 has the shape of the independent button 5b. Thus, it is possible that, when that user looks at the device icon 13, the user knows the independent button 5b, which can be used in addition to the arrow key 5a, regarding to the selected item almost without moving the eyes.

In the vehicle user interface device 1, the microcomputer 10 displays the guidance image, which indicates the function realized when the independent button 5b corresponding to the additional icon 16 is operated, in addition to the additional icon 16. Thus, it is possible that, when the user looks at the additional icon 16, the user knows a specific function that is realized by the operation of the independent button 5b corresponding to the additional icon 16. Accordingly, it is possible to prevent the user from confusing the additional icon 16 with the device icon 13, so that it is possible that, when the user selects the item, the user knows a switch that the user operates as the operation input device.

### Another Embodiment

Although the embodiment according to the present disclosure is explained, the present disclosure is not limited to the embodiments described above. The present disclosure can be various modifications, improvements, combinations or the like without departing from the scope of the present disclosure.

In the above embodiment, the arrow key 5a is selected and explained as the operation input device. The operation input device is not limited to this configuration. It is possible to be any configuration as long as the operation input device has a specific shape, and as long as the instruction direction is inputted according to the user operation.

Incidentally, in the above embodiment, the independent button 5b is selected and explained as the additional device. The additional device may be any configuration as long as the additional device has a specific shape and as long as the instruction content can be inputted according to the user operation.

In the above embodiment, an image such as a symbol, a mark, or the like is exemplified as the guide images 14a, 14b. It is not limited to this configuration. For example, the guide images 14a, 14b may be an image illustrating a character, a symbol or the like, and may be a combination thereof.

In the embodiment, the present disclosure is explained with the vehicle user interface device 1, it is not limited to a vehicle. The present disclosure may apply to various uses as long as a device including at least the display portion, the operation input device, and the display control means.

According to the present disclosure, a user interface device includes a display portion, an operation input device, and a display control portion. The display portion displays a menu screen including a plurality of items. The operation input device inputs an instruction direction corresponding to a user operation. The display control portion, when a cursor for enabling a user to select one of the plurality of items is displayed on the one of the plurality of items in the menu screen on the display portion, moves the cursor between the plurality of items according to the instruction direction inputted through the operation input device. The plurality of items, respectively, represents contents of a plurality of application processes prepared in advance.

In the present disclosure, the display control portion displays a device icon on the menu screen as the cursor. The device icon represents a shape of the operation input device.

According to this configuration, since the device icon is displayed on the menu screen, when the user selects an item on the menu screen, it is possible that the user knows a switch that the user operates as the operation input device, at a glance.

Since the device icon is displayed on the item as the cursor, it is possible that the user knows a selected item without moving the user's eye when the user looks at the device icon, compared to a case where the device icon and the cursor are displayed separately (referring to FIG. 8B).

According to the present disclosure, it is possible to improve operability to the user by the user interface device in which a user selects one of the plurality of items, which are displayed in the menu screen, with the cursor, which moves between the plurality of items.

Incidentally, as the operation input device, as long as an operation input device has a specific shape, it is possible to have any mode. For example, when the operation input device inputs the instruction direction according to one of push positions of the operation input device, the one of push positions which is depressed by the user, the device icon may include push icon portions corresponding to the push positions of the operation input device, and, on each push icon portion of the device icon, the display control portion may superimpose a guide image for prompting the user operation.

According to this configuration, since the guide image is displayed on the push icon portion of the device icon, it is possible that the user easily knows a portion in the operation input device which the user should operate, during displaying of the menu screen.

The display control portion may display the guide image for indicating a movement direction of the device icon. The device icon is positioned to the one of the plurality of items. The display control portion may determine the one of plurality of items as an object item, and the display control portion may display the guide image for indicating a function that is realized by one of the plurality of application processes corresponding to the object item.

In the former case, it is possible that, when the user pushes a position of the operation input device, the user easily knows a movement direction of the device icon, which corresponds to the cursor. In the latter case, it is possible that, when the user pushes a position of the operation input device, the user easily knows a kind of function realized by the selected item.

Incidentally, the guide image may be an image illustrating a character, a symbol, or the like and may be a combination thereof. The display control portion may determine the push position of the operation input device, which becomes inoperable by the user according to a position of the device icon, as an object position, and gray out the guide image corresponding to the object position.

According to the configuration, for example, when it becomes inoperable to move the device icon as the cursor or when it becomes impossible to select an operation to realize a function by the selected item, since the corresponding guide image is grayed out, it is possible that the user easily knows a relationship between a position and an item of the device icon and a selectable/non-selectable operation, compared to a mode where the guide image is not displayed at all.

The display control portion determines which of the push positions is inoperable by the user, according to a position of the device icon. Each push position determined as being inoperable by the user is an object position. The display control portion may gray out the guide image corresponding to the object position.

According to this configuration, since the corresponding push icon portion is grayed out, it is possible that the user intuitively knows an object position of the operation input device which becomes inoperable, compared to a mode where only the guide image is grayed out.

The device icon is positioned to the one of the plurality of items. The display control portion determines the one of plurality of items as an object item. The display control portion superimposes an operating status image (corresponding to a run status image) on an area other than the push icon portions in the device icon. The operating status image represents an operating status of the operation object device, and corresponds to a run image in the present embodiment. The operation object device executes the one of the plurality of application processes corresponding to the object item.

According to this configuration, the guide image is displayed on the push icon portion in the device icon. The image which changes based on the operating status of the operation object device is displayed on the area other than the push icon portion. Thus, it is possible that the user easily knows the push portion of the operation input device, and that the user easily knows the operating status of the operation object device on the menu screen.

According to this configuration, since it may be possible to display the menu screen without displaying the application screen, it is possible that the user selects another item without an operation to back from the application screen to the menu screen. Herein, the application screen indicates an output content of the application process when the operation object device executes the application process. Thus, it is possible to improve the operability to the user.

The operation object device may be a device which executes the application process corresponding to the item selected by the user through the operation input device. The operation object device may be a device connected to the user interface device, or may be the user interface device itself.

The user interface device in the present disclosure may include an additional device that is separated from the operation input device. The additional device is provided to input the user operation relating to at least one of the plurality of application processes.

The one of the plurality of items, to which the device icon is positioned, is determined as an object item by the display control portion.

When the user operation of the additional device corresponds to an application process that corresponds to the object item, the display control portion may display an additional icon on the menu screen. The additional icon is adjacent to the device icon. The additional icon represents a shape of the additional device.

According to the configuration, since an icon (corresponding to the additional icon) representing the shape of the additional device is displayed adjacent to the device icon, when the user looks at the device icon, it is possible that the user knows the additional device which can be used in addition to the operation input device regarding to the selected item almost without moving the user's eye.

It is preferable that the display control portion displays a guidance image and the additional icon. The guidance image represents a function realized by an operation of the additional device. The additional device corresponds to the additional icon. According to this configuration, it is possible that the user surely understand a specific function realized by an operation of the additional device when the user looks at the additional icon. The additional device corresponds to the additional icon. Furthermore, according to this configuration, it is possible to prevent the user from confusing the additional icon with the device icon, and therefore, it is possible that, when the user selects the item, the user knows a switch that the user should operate as the operation input device.

It is possible that the present disclosure is distributed to a market as a program. The program corresponds to a software which causes a computer to function as the display control portion. The computer is connected to the display portion and the operation input device. Thus, it is possible to configure the user interface device by combining the software with a hardware corresponding to the software.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A user interface device for controlling a display portion for displaying a menu screen including a list of buttons and a cursor comprising:
an operation input device for inputting an instruction direction corresponding to a user operation; and
a display control portion for controlling the display portion to display a shape of the operation input device as the cursor and to move the cursor among the list based on the instruction direction, wherein
the display control portion superimposes at least one guide image on the cursor, and
the guide image represents at least one of an operable direction of the operation input device and a function of a button based on a position of the cursor on the list.

2. The user interface device according to claim 1, wherein:
each of the buttons represents contents of one of a plurality of application processes prepared in advance.

3. The user interface device according to claim 2, wherein
the operation input device inputs the instruction direction according to one of push positions of the operation input device, the one of push positions being depressed by a user, and
the cursor includes push icon portions corresponding to the push positions of the operation input device.

4. The user interface device according to claim 3, wherein
when the cursor is positioned to one of the buttons, the display control portion determines the one of the buttons as an object button, and
the function is realized by the one of the plurality of application processes corresponding to the object button.

5. The user interface device according to claim 3, wherein
the display control portion determines which of the push positions is inoperable by the user, according to a position of the cursor,
each push position that is determined as being inoperable by the user is an object position, and
the display control portion grays out the guide image corresponding to the object position.

6. The user interface device according to claim 3, wherein
the user interface device is coupled with an operation object device, which executes the one of the plurality of application processes corresponding to one of the buttons selected by the user through the operation input device,
the cursor is positioned to the one of the buttons,
the display control portion determines the one of the buttons as an object button,
the display control portion superimposes an operating status image on an area other than the push icon portions in the cursor,
the operating status image corresponds to an operating status of the operation object device, and
the operation object device executes the one of the plurality of application processes corresponding to the object button.

7. The user interface device according to claim 2, wherein
the operation input device inputs the instruction direction according to one of push positions of the operation input device, the one of push positions being depressed by a user,
the cursor includes push icon portions corresponding to the push positions in the operation input device,
the display control portion determines which of the push positions is inoperable by the user in the operation input device, according to a position of the cursor,
each push position determined as being inoperable by the user is an object position, and
the display control portion grays out each push icon portion corresponding to the object position.

8. The user interface device according to claim 2, further comprising
an additional device that is separated from the operation input device, wherein
the additional device is provided to input the user operation relating to at least one of the plurality of application processes,
one of the buttons, to which the cursor is positioned, is determined as an object button by the display control portion,
when the user operation of the additional device corresponds to the one of the plurality of application processes that corresponds to the object button, the display control portion displays an additional icon on the menu screen,
the additional icon is adjacent to the cursor, and
the additional icon represents a shape of the additional device.

9. The user interface device according to claim 8, wherein
the display control portion displays a guidance image and the additional icon,
the guidance image represents a function realized by an operation of the additional device, and
the additional device corresponds to the additional icon.

10. A non-transitory tangible computer readable storage medium storing a computer-executable program that causes a computer, which is connected to (i) a display portion for displaying a menu screen including a list of buttons and a cursor, and (ii) an operation input device for inputting an instruction direction corresponding to a user operation, to perform:
controlling the display portion to display a shape of the operation input device as the cursor and to move the cursor among the list based on the instruction direction, wherein
at least one guide image is superimposed on the cursor, and
the guide image represents at least one of an operable direction of the operation input device and a function of a button based on a position of the cursor on the list.

11. A user interface device comprising:
a display portion for displaying a menu screen including a plurality of buttons;
an operation input device for inputting an instruction direction corresponding to a user operation; and
a display control portion for, when a cursor for enabling a user to select one of the plurality of buttons is displayed on the one of the plurality of buttons in the menu screen on the display portion, moving the cursor between the plurality of buttons according to the instruction direction inputted through the operation input device, wherein
the plurality of buttons, respectively, represents contents of a plurality of application processes prepared in advance,
a device icon represents a shape of the operation input device, and
the display control portion displays the device icon on the menu screen as the cursor.

12. The user interface device according to claim 11, wherein
the operation input device inputs the instruction direction according to one of push positions of the operation input device, the one of push positions being depressed by the user,
the device icon includes push icon portions corresponding to the push positions of the operation input device, and
the display control portion superimposes a guide image on each push icon portion of the device icon, for prompting the user operation.

13. The user interface device according to claim 12, wherein
the display control portion displays the guide image for indicating a movement direction of the device icon.

14. The user interface device according to claim 12, wherein
the device icon is positioned to the one of the plurality of buttons,
the display control portion determines the one of the plurality of buttons as an object button, and
the display control portion displays the guide image for indicating a function that is realized by one of the plurality of application processes corresponding to the object button.

15. The user interface device according to claim 12, wherein
the display control portion determines which of the push positions is inoperable by the user, according to a position of the device icon,
each push position that is determined as being inoperable by the user is an object position, and
the display control portion grays out the guide image corresponding to the object position.

16. The user interface device according to claim 12, wherein
the user interface device is coupled with an operation object device, which executes one of the plurality of application processes corresponding to the one of the plurality of buttons selected by the user through the operation input device,
the device icon is positioned to the one of the plurality of buttons,
the display control portion determines the one of the plurality of buttons as an object button,
the display control portion superimposes an operating status image on an area other than the push icon portions in the device icon,
the operating status image corresponds to an operating status of the operation object device, and
the operation object device executes the one of the plurality of application processes corresponding to the object button.

17. The user interface device according to claim 11, wherein
the operation input device inputs the instruction direction according to one of push positions of the operation input device, the one of push positions being depressed by the user,
the device icon includes push icon portions corresponding to the push positions in the operation input device,
the display control portion determines which of the push positions is inoperable by the user in the operation input device, according to a position of the device icon,
each push position determined as being inoperable by the user is an object position, and
the display control portion grays out each push icon portion corresponding to the object position.

18. The user interface device according to claim 11, further comprising
an additional device that is separated from the operation input device, wherein
the additional device is provided to input the user operation relating to at least one of the plurality of application processes,
the one of the plurality of buttons, to which the device icon is positioned, is determined as an object button by the display control portion,
when the user operation of the additional device corresponds to the one of the plurality of application processes that corresponds to the object button, the display control portion displays an additional icon on the menu screen,
the additional icon is adjacent to the device icon, and
the additional icon represents a shape of the additional device.

19. The user interface device according to claim 18, wherein
the display control portion displays a guidance image and the additional icon,
the guidance image represents a function realized by an operation of the additional device, and
the additional device corresponds to the additional icon.

20. A non-transitory tangible computer readable storage medium storing a computer-executable program that causes a computer, which is connected to (i) a display portion for displaying a menu screen including a plurality of buttons and (ii) an operation input device for inputting an instruction direction corresponding to a user operation, to perform:
when a cursor for enabling a user to select one of the plurality of buttons is displayed on the one of the plurality of buttons on the display portion, moving the cursor on the display portion between the plurality of buttons according to the instruction direction inputted through the operation input device, wherein the plurality of buttons, respectively, represents contents of a plurality of application processes prepared in advance; and
displaying a device icon on the menu screen as the cursor, wherein the device icon represents a shape of the operation input device.
